(19) United States
(12) Patent Application Publication
(10) Pub. No.: US 2009/0044153 A1
(43) Pub. Date: Feb. 12, 2009

(54) USER INTERFACE

(75) Inventors: Phillip John Lindberg, Helsinki (FI); Sami Johannes Niemela, Helsinki (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/834,144

(22) Filed: Aug. 6, 2007

(51) Int. Cl. G06F 3/14

(52) U.S. Cl. 715/864

(57) ABSTRACT

It is presented a portable apparatus including a first element including a display; a second element, the first and second elements being rotatable in relation to each other around a longitudinal axis and a controller. The controller is configured to, when detecting a rotational user input including a rotational movement between the first element and the second element around the longitudinal axis, scroll content of the display such that the content is displayed at a position being fixed, within an interval of acceptance, in relation to the second element. Corresponding method, computer program product, user interface and system are also presented.

### FIELD

The disclosed embodiments generally relate to portable apparatuses and more particularly to user input in portable apparatus.

### BACKGROUND

User interfaces for controlling electronic devices have developed continuously since electronic devices first appeared on the market. Typically, displays are used for output and keypads are used for input, particularly in the case of portable electronic devices.

For large devices, larger screens and more refined input mechanisms allow for a rich and intuitive user interface. There is however a problem with user interfaces for small portable electronic devices, where displays are small and user input is limited. Any improvement in the user experience of such devices have an impact on usability and attractiveness.

Consequently, there is a need for an improved user interface for small portable electronic devices with a limited user interface.

### SUMMARY

In view of the above, it would be advantageous to solve or at least reduce the problems discussed above.

Generally, the above can be achieved by the attached independent patent claims.

According to a first aspect of the disclosed embodiments there has been provided a portable apparatus comprising: a first element comprising a display; a second element, the first and second elements being rotatable in relation to each other around a longitudinal axis; and a controller configured to, when detecting a rotational user input comprising a rotational movement between the first element and the second element around the longitudinal axis, scroll content of the display such that the content is displayed at a position being fixed, within an interval of acceptance, in relation to the second element.

Due to pixels of the display, the alignment with the second element may not be perfect and can differ up to one pixel. Also, during fast rotation, there may be a delay for detecting the rotation and scrolling the content. Furthermore, a slight deviation of a few pixels is acceptable from a user interface perspective.

The controller may further be configured to: detect a second user input comprising a movement in a first direction between the first element and the second element along the longitudinal axes; and execute software instructions associated with the second user input as a result of detecting the second user input.

The controller may further be configured to: detect a second user input comprising a first movement at a first time in a first direction between the first element and the second element along the longitudinal axes and a second movement at a second time in a second direction, the second direction being opposite to the first direction; and execute software instructions associated with the second user input as a result of detecting the second user input, the software instructions being determined using a difference between the first time and the second time.

The controller may be configured to: detect the second user input as a press of the first element towards the second element during a depression time; and execute a first set of software instructions when the depression time is shorter than a threshold time and a second set of software instructions when the depression time is longer than a threshold time.

The portable apparatus may be comprised in a device selected from the group consisting of a mobile communication terminal, a headset and a stylus.

A second aspect of the disclosed embodiments is a method for a portable apparatus comprising: detecting a rotational user input comprising a rotational movement between a first element of the portable apparatus and a second element of the portable apparatus, around a longitudinal axis of the portable apparatus; scrolling content of a display of the first element such that the content is displayed at a position being fixed, within an interval of acceptance, in relation to the second element.

The method may further comprise: detecting a second user input comprising a movement in a first direction between the first element and the second element along the longitudinal axes; and executing software instructions associated with the second user input.

The method may further comprise: detecting a second user input comprising a first movement at a first time in a first direction between the first element and the second element along the longitudinal axes and a second movement at a second time in a second direction, the second direction being opposite to the first direction; and executing software instructions associated with the second user input, the software instructions being determined using a difference between the first time and the second time.

The detecting may involve detecting the second user input as a press of the first element towards the second element during a depression time; and the executing may involve executing a first set of software instructions when the depression time is shorter than a threshold time and a second set of software instructions when the depression time is longer than a threshold time.

A third aspect of the disclosed embodiments is an apparatus comprising: means for detecting a rotational user input comprising a rotational movement between a first element of the portable apparatus and a second element of the portable apparatus, around a longitudinal axis of the portable apparatus; and means for scrolling content of a display of the first element such that the content is displayed at a position being fixed, within an interval of acceptance, in relation to the second element.

A fourth aspect of the disclosed embodiments is a computer program product comprising software instructions that, when executed in a mobile communication apparatus, performs the method according to the second aspect.

A fifth aspect of the disclosed embodiments is a user interface comprising: a first element comprising a display; a second element, the first and second elements being rotatable in relation to each other around a longitudinal axis; and wherein the user interface is configured to, when detecting a rotational user input comprising a rotational movement between the first element and the second element around the longitudinal axis, scroll content of the display such that the content is displayed at a position being fixed, within an interval of acceptance, in relation to the second element.

A sixth aspect of the disclosed embodiments is a system comprising: a portable apparatus; and a second apparatus, wherein the portable apparatus comprises: a first element comprising a display; a second element, the first and second elements being rotatable in relation to each other around a longitudinal axis; and a controller configured to, when detecting a rotational user input comprising a rotational movement between the first element and the second element around the longitudinal axis, scroll content of the display such that the content is displayed at a position being fixed, within an interval of acceptance, in relation to the second element; wherein the portable apparatus is arranged to communicate with the second apparatus. The second apparatus may be a mobile communication terminal.

It is to be noted that any feature of the first aspect may be applied to any or all of the second, third, fourth and fifth aspects. Furthermore, any feature of the second aspect may be applied to any or all of the first, third, fourth and fifth aspects.

Other features and advantages of the disclosed embodiment will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic perspective view illustrating an electronic pen device according to an embodiment.

FIGS. 3a and 3b are schematic front and top views of the mobile terminal of FIG. 1.

FIGS. 4a and 4b illustrate two use cases for an embodiment of the electronic pen device of FIG. 2.

FIG. 5 illustrate the internal component, software and protocol structure of the electronic pen device of FIG. 2.

FIGS. 6a and 6b illustrate how rotation can be used as user input in an embodiment of the electronic pen device of FIG. 2.

FIGS. 7a and 7b illustrate how pushing can be used as user input in an embodiment of the electronic pen device of FIG. 2.

FIG. 8 is a flow chart illustrating a method according to an embodiment to be executed in the mobile terminal of FIG. 2.

### DETAILED DESCRIPTION OF EMBODIMENTS

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

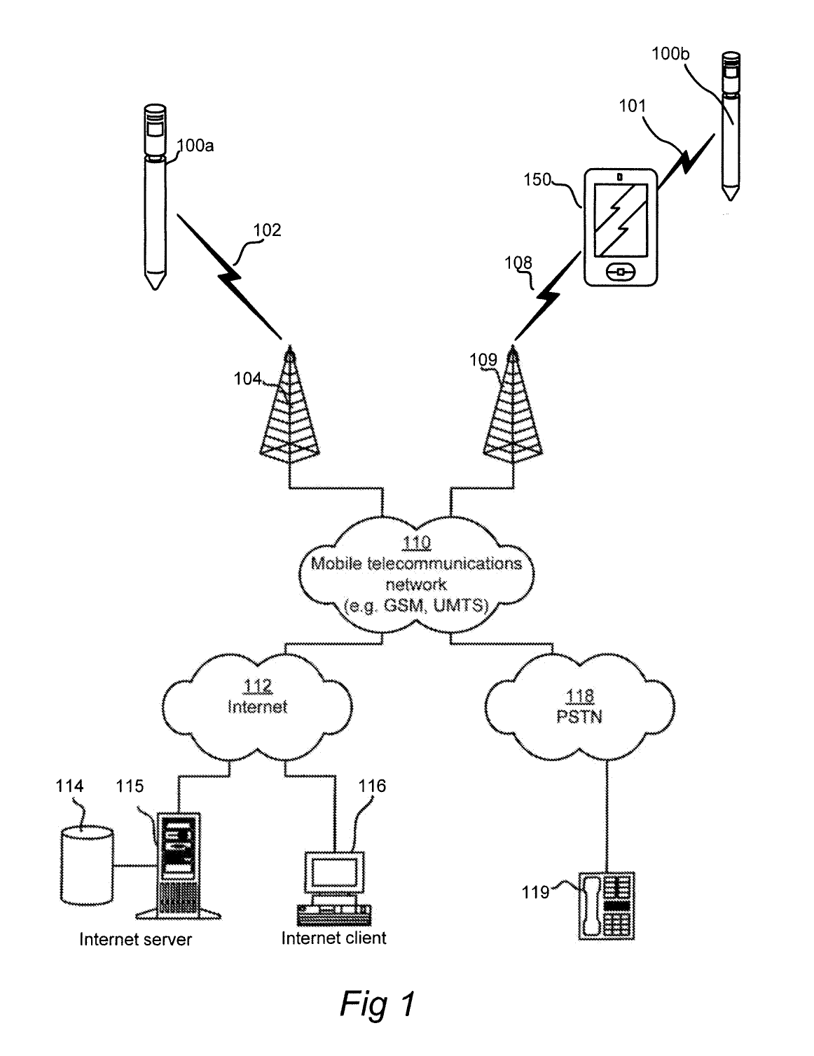

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100a, in the form of an electronic pen device, and other devices, such as another mobile terminal 150 or a stationary telephone 119. It is to be noted that for different embodiments of the mobile terminal 100a and in different situations, different telecommunications services, as discussed above, may or may not be available; the invention is not limited to any particular set of services in this respect.

Another embodiment of an electronic pen device 100b is connected to the mobile terminal 150 over a local connection 101, e.g. Bluetooth™ or IrDA.

The mobile terminals 100a, 150 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 112, which may be Internet or a part thereof. A server 115 has a data storage 114 and is connected to the wide area network 112, as is an Internet client computer 116.

A public switched telephone network (PSTN) 118 is connected to the mobile telecommunications network 110 in a familiar manner. Various telephone terminals, including the stationary telephone 119, are connected to the PSTN 118.

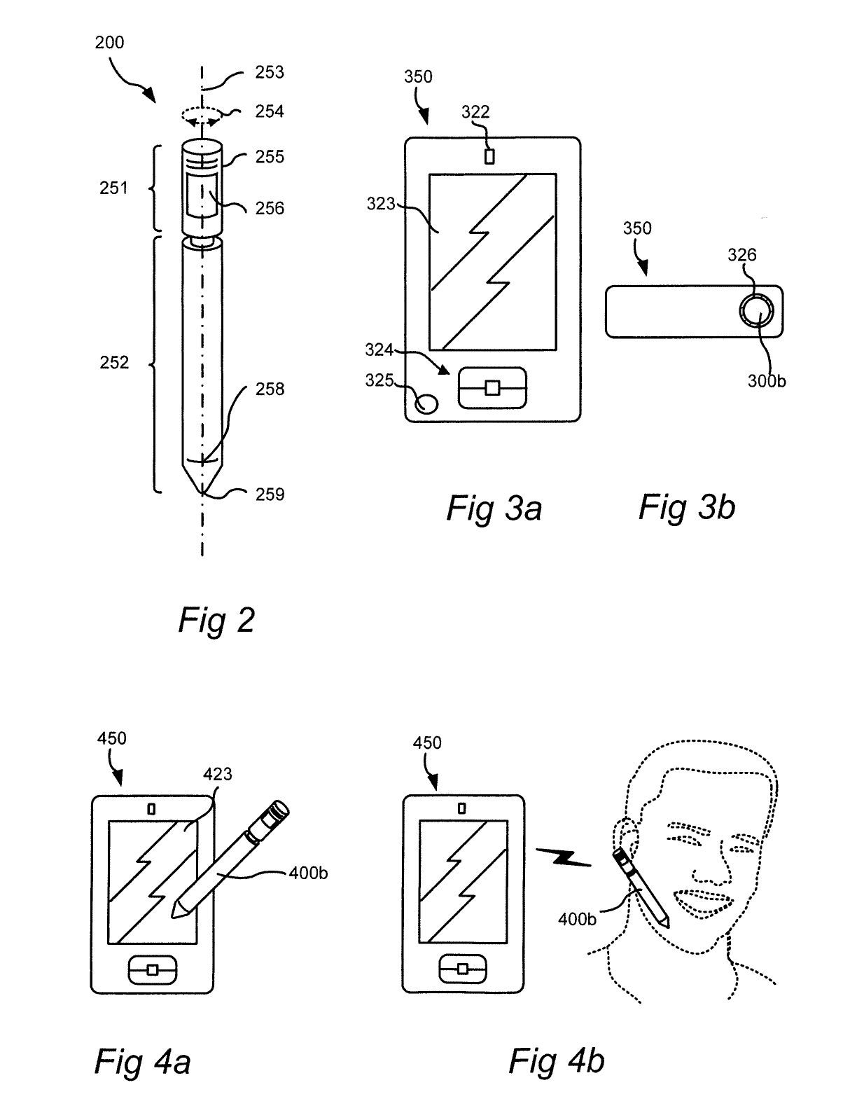

An embodiment 200 of the electronic pen devices 100a and 100b is illustrated in more detail in FIG. 2. The pen device 200 comprises a first element 251 and a second element 252, which are rotatable 254 around a longitudinal axis 253. Such a rotation between the two elements 251 and 252 can be interpreted as user input, as is described in more detail below. The first element 251 comprises a display 256 and optionally a speaker 255. The second element 258 optionally comprises a microphone 258. The lower tip 259 of the electronic pen 200 can either be a stylus-type tip, or it can optionally include a pen, allowing a user to also write on normal paper. Note that, optionally the display 256 may be placed on the second element 258 instead of on the first element 251 as in FIG. 2.

An embodiment 350 of the mobile terminal 150 is illustrated in more detail in FIGS. 3a and 3b. The mobile terminal 350 comprises a speaker or earphone 322, a microphone 325, a touch-sensitive display 323 and a set of keys 324. Available from the top end of the mobile terminal 350 is a cavity 326, capable of holding an electronic pen device 300b, such as the pen device 200 of FIG. 2. In this embodiment, the mobile pen device 300b is connectable to the mobile terminal 350, e.g. using Bluetooth™, whereby the electronic pen device does not need to have the capability to connect to a mobile communication network in itself; this task can be performed by the mobile terminal 350. This embodiment is also illustrated by the mobile terminal 150 and the electronic pen device 100b of FIG. 1. In this embodiment, the electronic pen can thus conveniently be stored in the cavity 326 when not in use.

FIGS. 4a and 4b illustrate two use cases for an embodiment of the electronic pen device of FIG. 2.

In FIG. 4a, it is shown how the electronic pen device 400b can be used as a stylus, allowing accurate user input on the display 423 of the mobile terminal 450, such as the mobile terminal 350 of FIG. 3.

In FIG. 4b, it is shown how the electronic pen device 400b can be used as a headset while in contact with the mobile terminal 450. Optionally, a clip (not shown) can be fastened to the pen device 400b to allow the pen device 400b to be hung on an ear of a user.

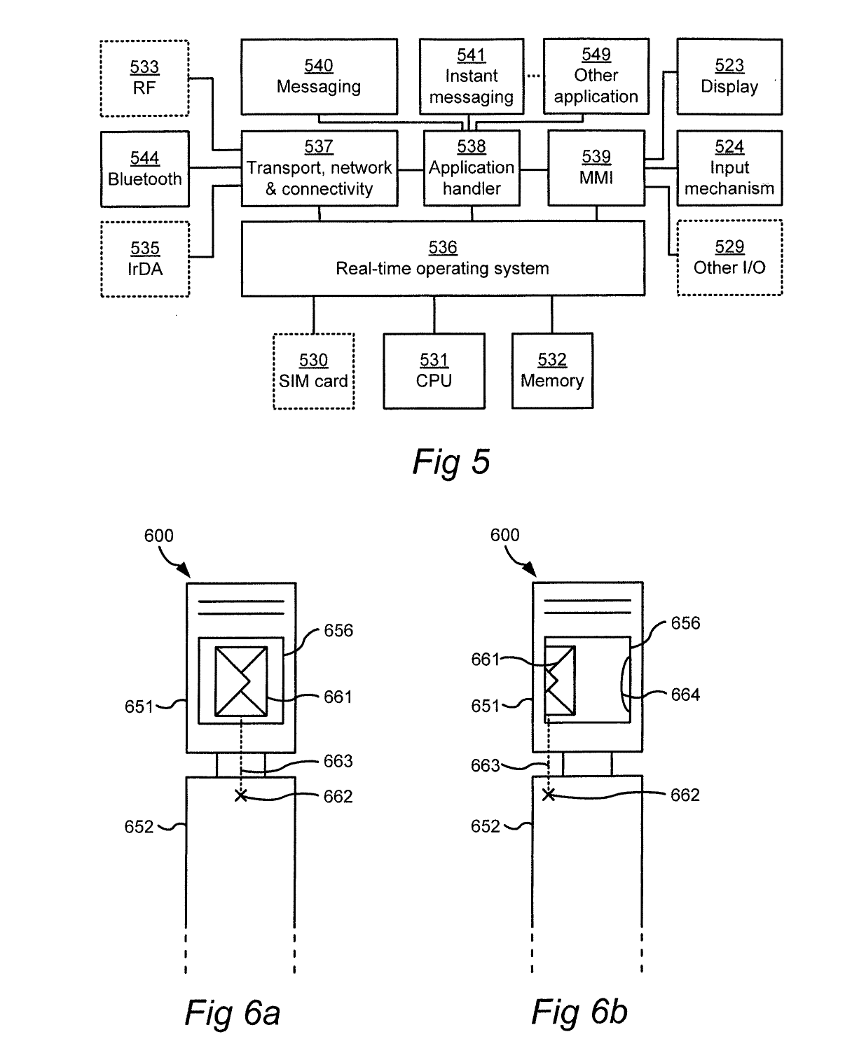

The internal component, software and protocol structure of the electronic pen device 200 will now be described with reference to FIG. 5. The electronic pen device has a controller 531, which is responsible for the overall operation of the electronic pen device and is preferably implemented by any commercially available CPU (“Central Processing Unit”), DSP (“Digital Signal Processor”) or any other electronic programmable logic device. The controller 531 has associated electronic memory 532 such as RAM memory, ROM memory, EEPROM memory, flash memory, hard drive, optical storage or any combination thereof. The memory 532 is used for various purposes by the controller 531, one of them being for storing data and program instructions for various software in the electronic pen device. The software can include a real-time operating system 536, drivers for a man-machine interface (MMI) 539, an application handler 538 as well as various applications. The applications can include a messaging application 540 for SMS (short messaging service), MMS (multimedia messaging service) and/or e-mail, an instant messaging application 541, as well as various other optional applications 542, such as applications for voice calling, media playing, a calendar application, etc.

The MMI 539 also includes one or more hardware controllers, which together with the MMI drivers cooperate with the display 523/256, one or more electro-mechanical input mechanisms 524 which converts mechanical input to an electrical signal, as well as various other optional I/O devices 529 such as microphone, speaker, vibrator, ringtone generator, LED indicator, etc. The user may operate the electronic pen device through the man-machine interface thus formed.

The software also includes various modules, protocol stacks, drivers, etc., which are commonly designated as 537 and which provide communication services (such as transport, network and connectivity) for a Bluetooth interface 534, an optional RF interface 533, and an optional IrDA interface 535. When the electronic pen device is configured to have mobile network access, the RF interface 533 comprises an internal or external antenna as well as appropriate radio circuitry for establishing and maintaining a wireless link to a base station (e.g., the link 102 and base station 104 in FIG. 1). As is well known to a person skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

Optionally, the electronic pen device also has a SIM card 530 and an associated reader. As is commonly known, the SIM card 530 comprises a processor as well as local work and data memory.

FIGS. 6a and 6b illustrate how rotation can be used as user input in an embodiment of the electronic pen device of FIG. 2. The display 656 of the first element 651 of the electronic pen device 600 shows an icon 661. The icon 661 is aligned with the second element 652 during any movement between the first element 651 and the second element 652. This alignment is here illustrated by the horizontal centre of the icon 651 being aligned along an imaginary line 663 with an imaginary point 662 of the second element 652.

In FIG. 6b, the second element 652 has been rotated to the left in relation to the first element 651 of the electronic pen device 600, along the longitudinal axis 253 as seen in FIG. 2. The icon 661 is scrolled to the left accordingly, whereby the horizontal centre of the icon 661 is still aligned to the imaginary point 662. The position of the imaginary point 662 is fixed in relation to the second element 652 in FIGS. 6a and 6b and hence the imaginary line 663 has also been moved to the left in FIG. 6b. A new icon 664 is scrolled in from the right of the display 656.

In other words, when the user rotates the first element 651 relative the second element 652 (or vice versa—as in the example above with reference to FIGS. 6a and 6b), the controller in the electronic pen device detects the rotation using the electro-mechanical input mechanism 524 and scrolls any content on the display, such that the content is fixed in relation to the second element 652.

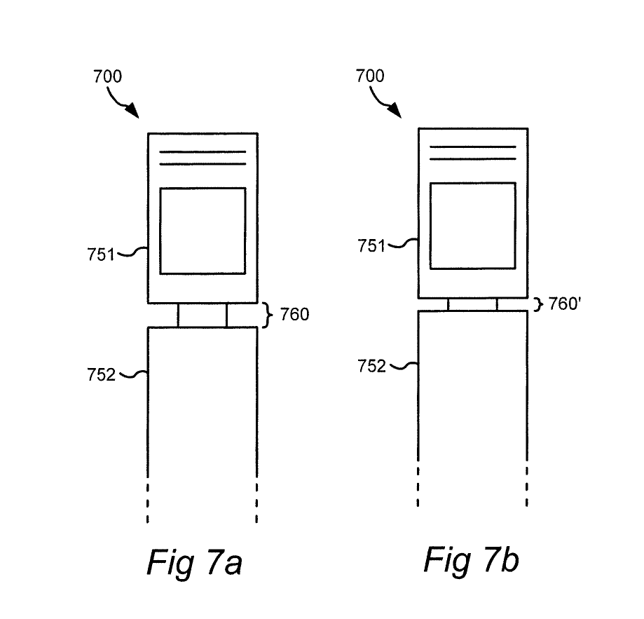

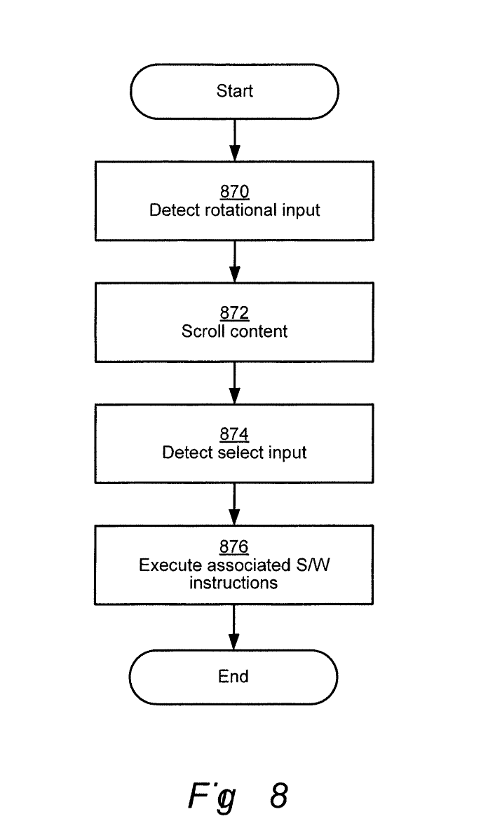

FIGS. 7a and 7b illustrate how pushing can be used as user input in an embodiment of the electronic pen device of FIG. 2. In FIG. 7a, the electronic pen device is in a default mode. The distance between the first element 751 and the second element 752 is here indicated by the measurement 760.

In FIG. 7b, the user has pushed the first element towards the second element, essentially along the longitudinal axis 253 as seen in FIG. 2. This is indicated by a second measurement 760′ indicating a shorter distance between the first element 751 and the second element 752 compared to the distance 760 of FIG. 7a. In this embodiment, when the user releases the pressure, the electronic pen device is biased towards the configuration shown in FIG. 7a.

The controller of the electronic pen device 700 can thereby detect, using electro-mechanical input mechanism 524, when the user pushes the two elements 751, 752 towards each other.

Consequently, there are at least two ways of providing user input to the electronic pen device—rotation and push. In one embodiment, the first element can be rotated to select a communication channel (voice, instant messaging, short messaging, presence, etc.). The first element may also be pushed, providing different types of activation, such as sequences (1 press=user input X, 2 presses=user input Y, 3 presses=user input Z), stepped presses (2 or 3 stages or depths), or short/long press variations. A hierarchical menu system can thus be constructed.

Here now follows a couple of examples to illustrate the use of disclosed embodiments.

### EXAMPLE 1

The electronic pen device controls two channels (voice and SMS) with three rotational positions—voice, SMS, or both. The user selects the most appropriate channel according to their context—for examples; when riding a bike “voice” is selected, or, when at a concert “SMS” is selected, or when standing at a bus stop “both” is selected. This information (which channel the user has selected) can inform the network of the user's preference, which thus communicates to the user's contacts (family, friends, associates, etc.) that the user is using a limited input device—helping make the response (or lack there of) socially acceptable and contributing metadata to further explain the users situation (presence).

The user can, for example, accept calls only, pressing to accept (answer) and pressing again to end the call (hang-up). The user can also be notified that they have received an SMS (via a visual cue such as an icon on the display or a change of a LED backlight colour) whereby the user can press to listen to it, the text being read to the user using voice synthesis.

### EXAMPLE 2

This example is similar to example 1, but it is a more elaborate version involving the use of push sequences, steps, or long presses/short presses. The user listens to an SMS and has the option to send a basic response, such as “Yes” or “No”. After listening to the message the user can press sequences, such as once (=yes) or twice (=no). This could also be achieved with a pusher that can be pushed to a plurality of positions, or steps, optionally with increasing physical resistance. In such an example a first step could imply “yes”, a second step could imply “no”, and a third step could imply “OK”. Furthermore, the message could also be handled with short/long presses, such as short=replay message, long=delete message. The sender could thus be informed that the message has been deleted, which in turn could be interpreted as indication that the message has been read.

In all of these cases the fact that the device is in use can inform other involved users that they can communicate, but in a limited fashion. This basic communication can contribute to a more effective and appropriate communication in an always-on world of the future.

FIG. 8 is a flow chart illustrating a method according to an embodiment to be executed in the mobile terminal of FIG. 2.

In an initial detect rotational input step 870, rotational input is detected, as described in conjunction with FIGS. 6a and 6b above.

In a scroll content step 872, the content is scrolled in accordance with the detected rotation. The scrolling is performed within an interval of acceptance. Due to pixels of the display, the alignment with the second element may not be perfect and can differ up to one pixel. Also, during fast rotation, there may be a delay for detecting the rotation and scrolling the content. Furthermore, a slight deviation of a few pixels is acceptable from a user interface perspective.

In a detect select input step 874, a select input is detected. The select input can for example be the push input described in conjunction with FIGS. 7a and 7b above.

In an execute associated S/W instructions step 876, software instructions associated with the select input is detected. This software can thereby use the rotational position to determine what action is selected by the user.

Although the invention has above been described using an embodiment in an electronic pen device, the invention is applicable to any type of portable apparatus where rotational input along a longitudinal axis is used.

The invention has mainly been described above with reference to a few embodiments. However, as is readily appreciated by a person skilled in the art, other embodiments than the ones disclosed above are equally possible within the scope of the invention, as defined by the appended patent claims.

1. A portable apparatus comprising:
a first element comprising a display;
a second element, said first and second elements being rotatable in relation to each other around a longitudinal axis; and
a controller configured to, when detecting a rotational user input comprising a rotational movement between said first element and said second element around said longitudinal axis, scroll content of said display such that said content is displayed at a position being fixed, within an interval of acceptance, in relation to said second element.

2. The portable apparatus according to claim 1, wherein said controller is further configured to:
detect a second user input comprising a movement in a first direction between said first element and said second element along said longitudinal axes; and
execute software instructions associated with said second user input as a result of detecting said second user input.

3. The portable apparatus according to claim 1, wherein said controller is further configured to:
detect a second user input comprising a first movement at a first time in a first direction between said first element and said second element along said longitudinal axes and a second movement at a second time in a second direction, said second direction being opposite to said first direction; and
execute software instructions associated with said second user input as a result of detecting said second user input, said software instructions being determined using a difference between said first time and said second time.

4. The portable apparatus according to claim 3, wherein said controller is configured to:
detect said second user input as a press of said first element towards said second element during a depression time; and
execute a first set of software instructions when said depression time is shorter than a threshold time and a second set of software instructions when said depression time is longer than a threshold time.

5. The portable apparatus according to claim 1, wherein said portable apparatus is comprised in a device selected from the group consisting of a mobile communication terminal, a headset and a stylus.

6. A method for a portable apparatus comprising:
detecting a rotational user input comprising a rotational movement between a first element of said portable apparatus and a second element of said portable apparatus, around a longitudinal axis of said portable apparatus;
scrolling content of a display of said first element such that said content is displayed at a position being fixed, within an interval of acceptance, in relation to said second element.

7. The method according to claim 6, further comprising:
detecting a second user input comprising a movement in a first direction between said first element and said second element along said longitudinal axes; and
executing software instructions associated with said second user input.

8. The method according to claim 6, further comprising:
detecting a second user input comprising a first movement at a first time in a first direction between said first element and said second element along said longitudinal axes and a second movement at a second time in a second direction, said second direction being opposite to said first direction; and
executing software instructions associated with said second user input, said software instructions being determined using a difference between said first time and said second time.

9. The method according to claim 8, wherein
said detecting involves detecting said second user input as a press of said first element towards said second element during a depression time; and
said executing involves executing a first set of software instructions when said depression time is shorter than a threshold time and a second set of software instructions when said depression time is longer than a threshold time.

10. An apparatus comprising:
means for detecting a rotational user input comprising a rotational movement between a first element of said portable apparatus and a second element of said portable apparatus, around a longitudinal axis of said portable apparatus; and
means for scrolling content of a display of said first element such that said content is displayed at a position being fixed, within an interval of acceptance, in relation to said second element.

11. A computer program product comprising software instructions that, when executed in a mobile communication apparatus, performs the method according to claim 6.

12. A user interface comprising:
a first element comprising a display;
a second element, said first and second elements being rotatable in relation to each other around a longitudinal axis; and
wherein said user interface is configured to, when detecting a rotational user input comprising a rotational movement between said first element and said second element around said longitudinal axis, scroll content of said display such that said content is displayed at a position being fixed, within an interval of acceptance, in relation to said second element.

13. A system comprising:
a portable apparatus; and
a second apparatus,
said portable apparatus comprising:
a first element comprising a display;
a second element, said first and second elements being rotatable in relation to each other around a longitudinal axis; and
a controller configured to, when detecting a rotational user input comprising a rotational movement between said first element and said second element around said longitudinal axis, scroll content of said display such that said content is displayed at a position being fixed, within an interval of acceptance, in relation to said second element;
wherein said portable apparatus is arranged to communicate with said second apparatus.

14. The system according to claim 13, wherein said second apparatus is a mobile communication terminal.
